(19) United States
(12) Patent Application Publication
(10) Pub. No.: US 2006/0015311 A1
(43) Pub. Date: Jan. 19, 2006

(54) Circuit design support method and system

(75) Inventors: Sheng-Yow Chen, Taichung City (TW); Hsin-Lan Chang, Jhongli City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Airoha Technology Corp.

(21) Appl. No.: 11/176,513

(22) Filed: Jul. 7, 2005

(30) Foreign Application Priority Data
Jul. 14, 2004 (TW) 93120970

(51) Int. Cl. G06F 17/50

(52) U.S. Cl. 703/14

(57) ABSTRACT

A method for circuit design support. A device instance identity is acquired. A device specification screen comprising at least one input field for entering at least one manufacturing parameter corresponding to the device instance identity is displayed. At least one target electrical characteristic variation is determined by applying the manufacturing parameter, a maximum extreme case and a minimum extreme case to a simulation model. The target electrical characteristic variation is displayed on the device specification screen.

### BACKGROUND

The invention relates to design support technology, and more particularly, to a system and method for circuit design support.

Design tools are typically employed by circuit designers to design integrated circuits (ICs). The most common design tools are the so-called simulated-program-with-integrated-circuit-emphasis (SPICE) and the fast device level simulators (e.g., Star-Sim, ATS, MACH TA, and TIMEMILL). Typically, design tools, such as SPICE and fast device level simulators, describe an individual device and its connections in a line-by-line manner. Examples of individual devices are resistors, capacitors, inductors, bipolar junction transistors, and metal oxide semiconductor field effect transistors (MOSFETs). In a design tool, each line, which includes a description of a device, is sometimes referred to as a device specification instance.

A netlist developed by a design tool, includes three sections, a circuit description section, a models section, and an analysis section. The circuit description section contains a description of individual device and sub-circuit behavior. Typically, the models section comprises a library of model parameters, model parameter values, and model equations. Generally, the behavior of each type of device (e.g., a MOSFET) can be simulated by at least one model equation, which includes a combination of model parameters. The analysis section typically includes analysis instructions to simulate a device, sub-circuit, or circuit (e.g., output voltage over time) using information in the circuit description section and the models section.

Typically, the IC design cycle includes three sequential phases of schematic design, circuit simulation and layout design. Typically, the layout design phase is initiated after an IC is developed in the schematic design phase and may pass various simulations. Alternatively, if the developed IC fails in the simulation phase, it must be modified. In the simulation phase, normal simulation and corner simulation are typically performed. The object of normal simulation is to determine whether a developed IC is regular under normal conditions. The conventional method for corner simulation involves a pair of model parameter sets representing process extremes, often referred to as “fast”/“slow” or “high”/“low” corners. The corner simulation predicts whether increasing some parameters larger than their designated value makes the overall result of an objective better or worse.

A developed IC design typically fails in corner simulation because the overall result of objectives in process extremes cannot be predicted in the schematic design phase, thus, much time is wasted in numerous IC design modifications and iterative simulations. Therefore, a need exists for a method and system of circuit design support facilitating to reduce the frequency of modification.

### SUMMARY

An embodiment of the invention provides a method for circuit design support. A schematic design diagram comprising a device instance corresponding thereto instance identity is displayed. A device specification screen comprising at least one input field for entering at least one manufacturing parameter corresponding to the device instance identity is displayed. At least one target electrical characteristic variation is determined by applying the manufacturing parameter, a maximum extreme case and a minimum extreme case to a simulation model. The target electrical characteristic variation is displayed on the device specification screen.

Also provided is a machine-readable storage medium storing a computer program which, when executed, performs circuit design support by acquiring a device instance identity, displaying a device specification screen, the device specification screen comprising at least one input field for entering at least one manufacturing parameter corresponding to the device instance identity, the device instance identity corresponding to a semiconductor device type, determining at least one target electrical characteristic variation by applying the semiconductor device type, the manufacturing parameters, a maximum extreme case and a minimum extreme case to a simulation model, and displaying the target electrical characteristic variation on the device specification screen.

A system for circuit design support is further provided. The system comprises a storage device, an output device, a specification process unit and a schematic design unit (if required). The specification process unit acquires a device instance identity, sends a device specification screen comprising at least one input field for entering at least one manufacturing parameter corresponding to the device instance identity to the output device, acquires a simulation model from the storage device, determines at least one target electrical characteristic variation by applying the manufacturing parameter, a maximum extreme case and a minimum extreme case to the simulation model, and sends the device specification screen comprising the target electrical characteristic variation to the output device. The schematic design unit displays a schematic design diagram comprising a device instance corresponding to the device instance identity.

Preferably, the target electrical characteristic variation comprises regular, highest and lowest magnitudes of the target electrical characteristic. The maximum extreme case comprises the highest resistance, current, voltage, power level, operating temperature, maximum manufacturing variation or combination thereof. The minimum extreme case comprises the lowest resistance, current, voltage, power level, operating temperature, minimum manufacturing variation or combination thereof.

### BRIEF DESCRIPTION OF THE DRAWINGS

The aforementioned objects, features and advantages of the embodiment will become apparent by referring to the following detailed description of embodiment with reference to the accompanying drawings, wherein:

FIG. 1 is a diagram of a hardware environment of a circuit design support system according to an embodiment of the invention;

FIG. 2 is a flowchart showing a method for circuit design support according to an embodiment of the invention;

FIG. 3 is an exemplary schematic design diagram;

FIGS. 4a and 4b are diagrams of exemplary device specification screens;

FIG. 5 is the system architecture of a circuit support system according to an embodiment of the invention;

FIG. 6 is a diagram of a storage medium for storing a computer program providing the method of circuit design support according to an embodiment of the invention.

### DETAILED DESCRIPTION

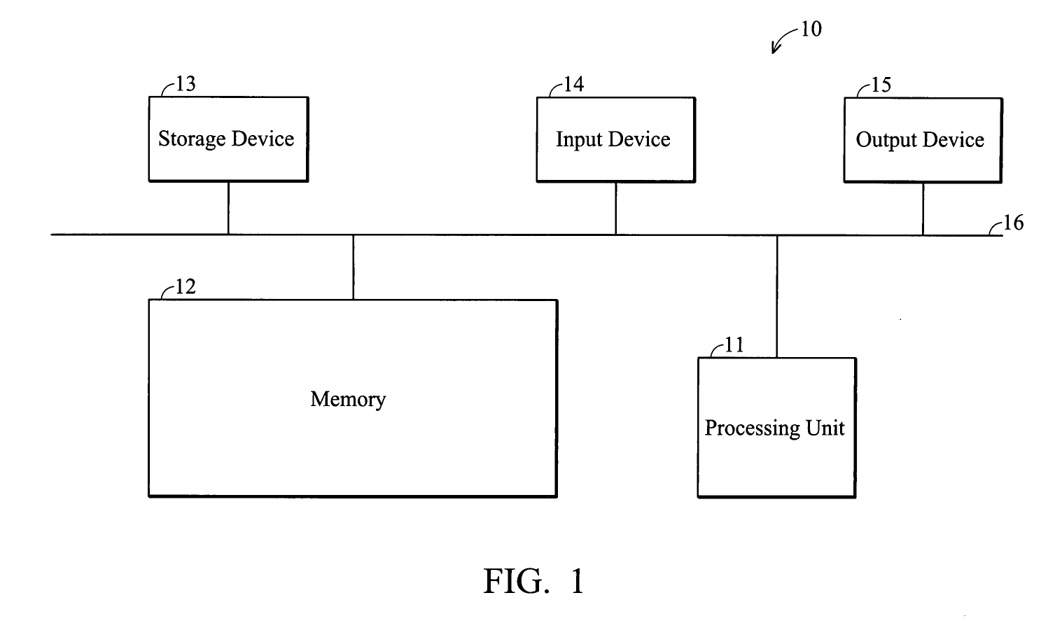

FIG. 1 is a diagram of a hardware environment of a circuit design support system according to an embodiment of the invention. The description of FIG. 1 is provides a brief, general description of suitable computer hardware and a suitable computing environment in conjunction with which at least some embodiments may be implemented. The hardware environment of FIG. 1 includes a processing unit 11, a memory 12, a storage device 13, an input device 14 and an output device 15. The processing unit 11 is connected by buses 16 to the memory 12, storage device 13, input device 14 and output device 15 based on Von Neumann architecture. Those skilled in the art will understand that at least some embodiments may be practiced with other computer system configurations, including hand-held devices, multiprocessor-based, microprocessor-based or programmable consumer electronics, network PCs, minicomputers, mainframe computers, and the like. There may be one or more processing unit 11, such that the processor of the computer comprises a single central processing unit (CPU), a micro processing unit (MPU) or multiple processing units, commonly referred to as a parallel processing environment. Memory 12 is preferably a random access memory (RAM), but may also include read-only memory (ROM) or flash ROM. The memory 12 preferably stores program modules executed by the processing unit 11 to perform circuit design support functions. Generally, program modules include routines, programs, objects, components, or others, that perform particular tasks or implement particular abstract data types. Some embodiments may also be practiced in distributed computing environments where tasks are performed by remote processing devices linked through a communication network. In a distributed computing environment, program modules may be located in both local and remote memory storage devices based on various remote access architecture such as DCOM, CORBA, Web object, Web Services or other similar architectures. The storage device 13 may be a hard drive, magnetic drive, optical drive, a portable drive, or nonvolatile memory drive. The drives and their associated computer-readable media (if required) provide nonvolatile storage of computer-readable instructions, data structures, program modules, texts, graphics, audio or video files.

Storage device 13 stores device libraries and simulation models. Device libraries store electrical models for semiconductor devices, such as npn bipolar junction transistors (npn BJTs). Each simulation model, preferably a corner simulation model, determines the best and worst electrical characteristics for given a particular type of semiconductor device, manufacturing parameters and the extreme cases. Note that the simulation models are well known in the art and as such description thereof is omitted herein.

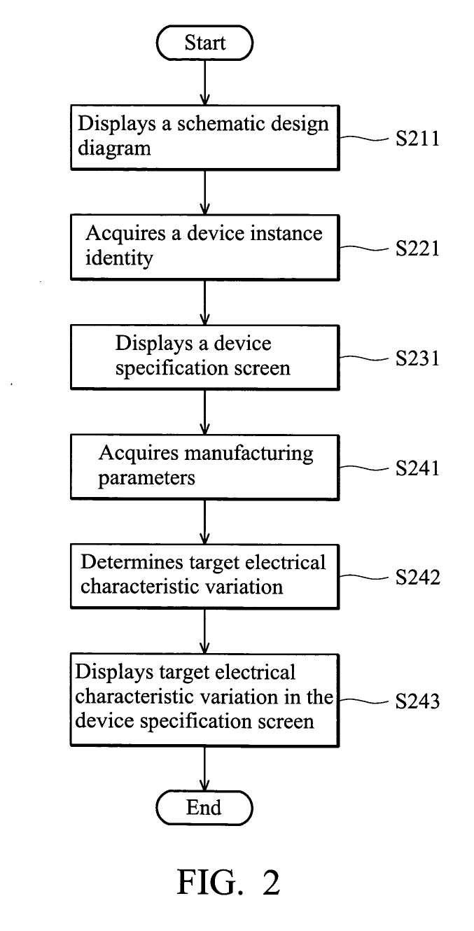

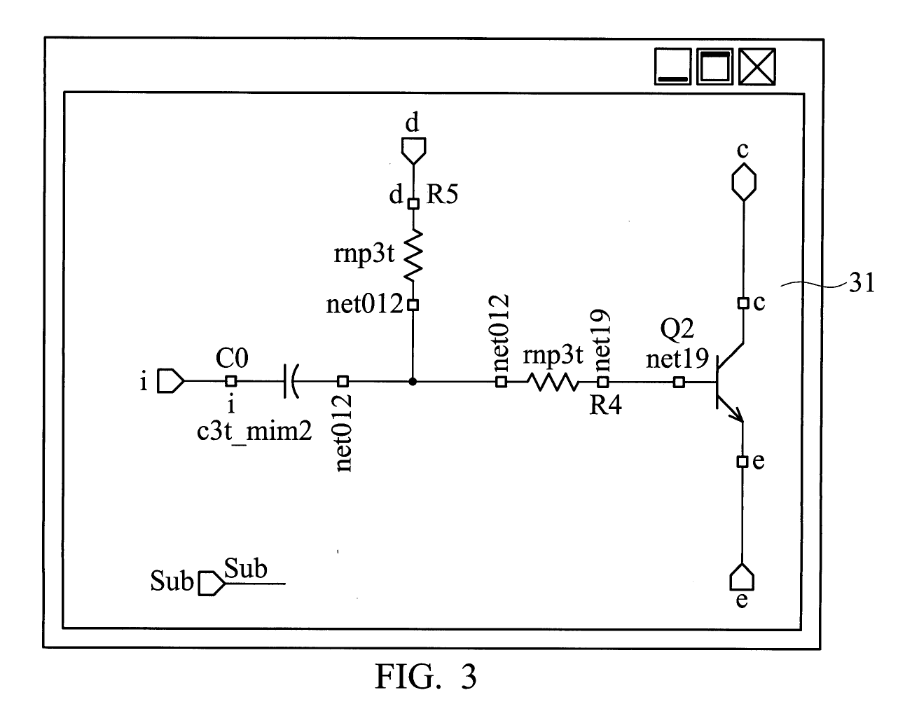

An embodiment of the invention discloses a circuit design support method executed by the processing unit 11. FIG. 2 is a flowchart showing a method for circuit design support according to an embodiment of the invention. In step S211, a schematic design diagram is displayed. The schematic design diagram may comprise one or more device instance, such as, a resistor, capacitor, inductor, BJT, and/or metal oxide semiconductor field effect transistor (MOSFET). FIG. 3 is an exemplary schematic design diagram. The schematic design diagram illustrates an npn BJC instance 31. In step S221, a device instance identity in the schematic design diagram is acquired.

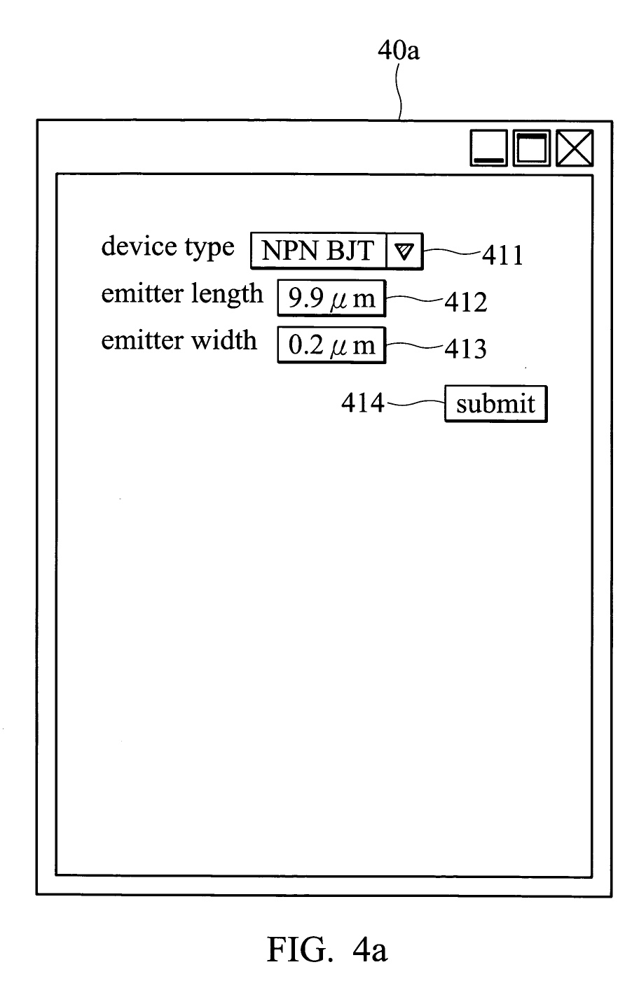

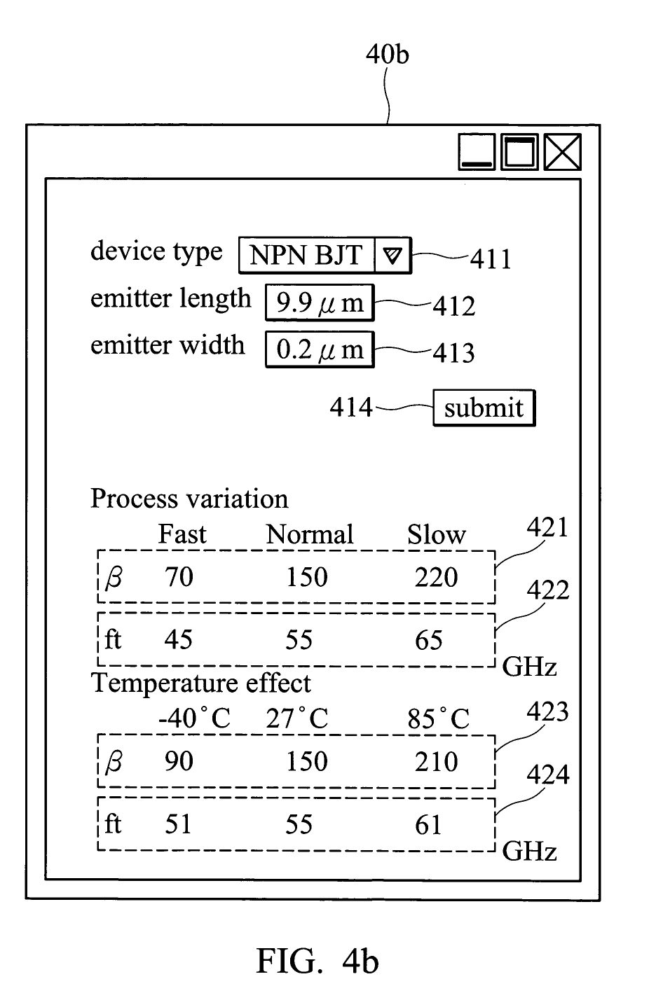

In step S231, a device specification screen is displayed. The device specification screen comprises multiple input fields for selecting a semiconductor device type and entering manufacturing parameters such as an emitter length, emitter width and the like. FIGS. 4a and 4b are diagrams of exemplary device specification screens. Referring to FIG. 4a, device specification screen 40a includes a selection interface object 411 containing semiconductor device types, an emitter length input field 412, an emitter width input field 413 and a button 414. In step S241, manufacturing parameters are received via the device specification screen. In step S242, at least one target electrical characteristic variation (e.g., a current gain, cut-off frequency range, or others) is determined using a simulation model for a given semiconductor device type, manufacturing parameters, the maximum extreme case (e.g., the highest resistance, current, voltage, power level, operating temperature, the maximum manufacturing variation or the combination thereof), and the minimum extreme case (e.g., the lowest resistance, current, voltage, power level, operating temperature, the minimum manufacturing variation or the combination thereof). In step S243, the target electrical characteristic variation is displayed on the device specification screen. Referring to FIG. 4b, device specification screen 40b shows current gain range 421 and cut-off frequency range 422 under manufacturing variation extremes, and current gain range 423 and cut-off frequency range 424 under operating temperature extremes.

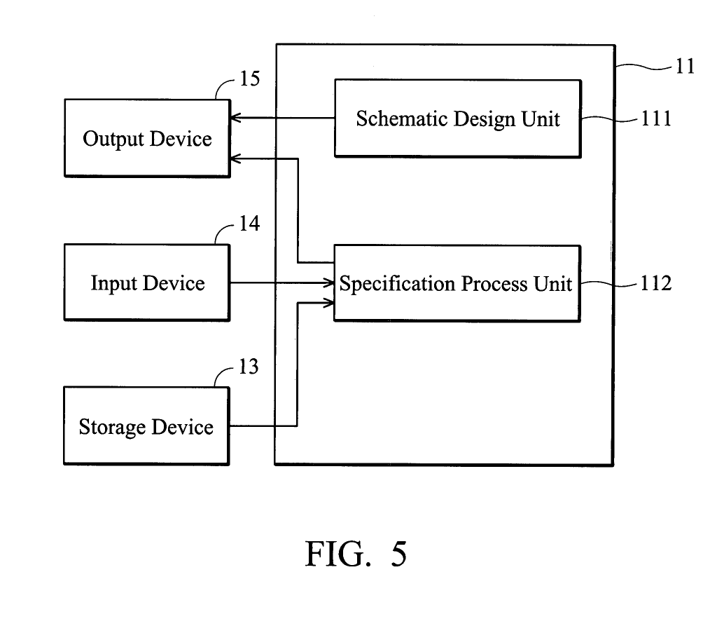

Also provided is a circuit support system. FIG. 5 is the system architecture of a circuit support system according to an embodiment of the invention. The circuit support system comprises a schematic design unit 111 and a specification process unit 112.

The schematic design unit 111 sends a schematic design diagram to the output device 15. The schematic design diagram may comprise one or more device instance, such as, a resistor, capacitor, inductor, BJT, and/or metal oxide semiconductor field effect transistor (MOSFET).

The specification process unit 112 acquires a device instance identity in the schematic design diagram via the input device 14. The specification process unit 112 sends a device specification screen to the output device 15. The device specification screen comprises multiple input fields for selecting a semiconductor device type and entering manufacturing parameters such as an emitter length, emitter width and the like. The specification process unit 112 acquires manufacturing parameters in the device specification screen via the input device 14, and a simulation model from the storage device 13. The specification process unit 112 determines at least one target electrical characteristic variation (e.g., a current gain, cut-off frequency range, or others) using the acquired simulation model for a given semiconductor device type, manufacturing parameters, the maximum extreme case (e.g., the highest resistance, current, voltage, power level, operating temperature, the maximum manufacturing variation or the combination thereof), and the minimum extreme case (e.g., the lowest resistance, current, voltage, power level, operating temperature, the minimum manufacturing variation or the combination thereof). The specification process unit 112 sends the target electrical characteristic variation on the device specification screen via the output device 15.

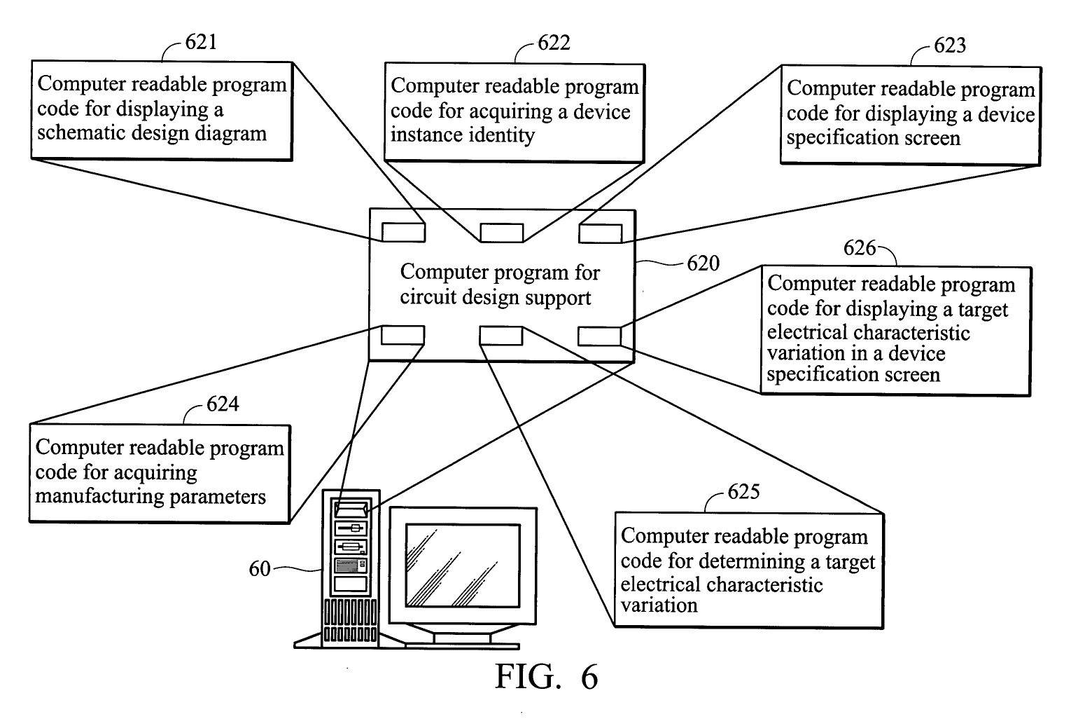

Further provided is a storage medium as shown in FIG. 6 storing a computer program 620 for executing the disclosed method of circuit design support. The computer program product includes a storage medium 60 having computer readable program code embodied in the medium for use in a computer system, the computer readable program code comprising at least computer readable program code 621 displaying a schematic design diagram, computer readable program code 622 acquiring a device instance identity, computer readable program code 623 displaying a device specification screen, computer readable program code 624 acquiring manufacturing parameters, computer readable program code 625 determining a target electrical characteristic variation and computer readable program code 626 displaying a target electrical characteristic variation in a device specification screen.

The methods and systems disclosed, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in the technology can still make various alterations and modifications without departing from the scope and spirit of this invention. Therefore, the scope of the present invention shall be defined and protected by the following claims and their equivalents.

What is claimed is:

1. A method for circuit design support, comprising:
acquiring a device instance identity;
displaying a device specification screen comprising at least one input field for entering at least one manufacturing parameter corresponding to the device instance identity;
determining at least one target electrical characteristic variation by applying the manufacturing parameter, a maximum extreme case and a minimum extreme case to a simulation model; and
displaying the target electrical characteristic variation on the device specification screen.

2. The method as claimed in claim 1 further comprising displaying a schematic design diagram comprising a device instance corresponding to the device instance identity.

3. The method as claimed in claim 1 wherein the target electrical characteristic variation comprises the highest and lowest magnitudes of the target electrical characteristic.

4. The method as claimed in claim 3 wherein the target electrical characteristic variation comprises a regular magnitude of the target electrical characteristic.

5. The method as claimed in claim 1 wherein the maximum extreme case comprises the highest resistance, current, voltage, power level, operating temperature, the maximum manufacturing variation or the combination thereof, and the minimum extreme case comprises the lowest resistance, current, voltage, power level, operating temperature, the minimum manufacturing variation or the combination thereof.

6. The method as claimed in claim 5 further comprising displaying a schematic design diagram comprising a device instance corresponding to the device instance identity.

7. The method as claimed in claim 6 wherein the target electrical characteristic variation comprises the highest and lowest magnitudes of the target electrical characteristic.

8. The method as claimed in claim 7 wherein the target electrical characteristic variation comprises a regular magnitude of the target electrical characteristic.

9. A machine-readable storage medium storing a computer program which, when executed, performs a method for circuit design support, the method comprising:
acquiring a device instance identity;
displaying a device specification screen, the device specification screen comprising at least one input field for entering at least one manufacturing parameter corresponding to the device instance identity, the device instance identity corresponding to a semiconductor device type;
determining at least one target electrical characteristic variation by applying the semiconductor device type, the manufacturing parameters, a maximum extreme case and a minimum extreme case to a simulation model; and
displaying the target electrical characteristic variation on the device specification screen.

10. A system for circuit design support, comprising:
a storage device;
an output device; and
a specification process unit acquiring a device instance identity, sending a device specification screen comprising at least one input field for entering at least one manufacturing parameter corresponding to the device instance identity to the output device, acquiring a simulation model from the storage device, determining at least one target electrical characteristic variation by applying the manufacturing parameter, a maximum extreme case and a minimum extreme case to the simulation model, and sending the device specification screen comprising the target electrical characteristic variation to the output device.

11. The system as claimed in claim 10 further comprising a schematic design unit displaying a schematic design diagram comprising a device instance corresponding to the device instance identity.

12. The system as claimed in claim 10 wherein the target electrical characteristic variation comprises the highest and lowest magnitudes of the target electrical characteristic.

13. The system as claimed in claim 12 wherein the target electrical characteristic variation comprises a regular magnitude of the target electrical characteristic.

14. The system as claimed in claim 10 wherein the maximum extreme case comprises the highest resistance, current, voltage, power level, operating temperature, the maximum manufacturing variation or the combination thereof, and the minimum extreme case comprises the lowest resistance, current, voltage, power level, operating temperature, the minimum manufacturing variation or the combination thereof.

15. The system as claimed in claim 14 further comprising a schematic design unit displaying a schematic design diagram comprising a device instance corresponding to the device instance identity.

16. The system as claimed in claim 15 wherein the target electrical characteristic variation comprises the highest and lowest magnitudes of the target electrical characteristic.

17. The system as claimed in claim 16 wherein the target electrical characteristic variation comprises a regular magnitude of the target electrical characteristic.
